(19) United States
(12) Patent Application Publication
(10) Pub. No.: US 2007/0008479 A1
(43) Pub. Date: Jan. 11, 2007

(54) Manufacturing apparatus for a liquid crystal display

(75) Inventors: Duck-Jong Suh, Seoul (KR); Baek-Kyun Jeon, Yongin-si (KR); Bong-Sung Seo, Yongin-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/484,318

(22) Filed: Jul. 11, 2006

(30) Foreign Application Priority Data
Jul. 11, 2005 (KR) 10-2005-0062261

(51) Int. Cl. G02F 1/1339

(52) U.S. Cl. 349/155

(57) ABSTRACT

A manufacturing apparatus for a liquid crystal display includes a spacer supply substrate in which a plurality of grooves are formed, a transfer roller having a surface to which a plurality of spacers deposited into the grooves are primarily transferred, and a support plate on which a substrate is mounted, wherein the primarily transferred spacers are secondarily transferred onto the substrate as the transfer roller rotates, wherein the diameter of each of the grooves is less than or equal to about seven times the diameter of each of the spacers. The diameter and depth of the groove of the spacer supply substrate and the tilt angle of a sidewall of the groove are controlled to prevent bead spacers from being stacked in two levels.

### CROSS-REFERENCE TO RELATED APPLICATION

This application claims priority to Korean Patent Application No. 10-2005-0062261 filed on Jul. 11, 2005, the contents of which are incorporated herein by reference in their entirety.

### BACKGROUND OF THE INVENTION

(a) Technical Field

The present disclosure relates to a manufacturing apparatus for a liquid crystal display.

(b) Discussion of the Related Art

A liquid crystal display is a widely used flat panel display. The liquid crystal display can include two sheets of display panels on which field generating electrodes are formed, and a liquid crystal layer interposed between the display panels. The liquid crystal display is a display device that controls transmittance of light that passes through the liquid crystal layer in such a manner that liquid crystal molecules of the liquid crystal layer are rearranged by applying a voltage to the field generating electrodes.

Upper and lower substrates of the liquid crystal display can be joined to each other at their peripheries by a sealant that seals a liquid crystal material. The upper and lower substrates can be spaced apart from each other by spacers in order to maintain a cell gap therebetween.

The spacers may be classified into bead spacers that are spherical and have an irregular pattern, and column spacers having a constant pattern.

The column spacers are formed by coating a photosensitive film on a color filter array panel and performing an exposure and development process on the coated photosensitive film so that spacer pattern corresponds to portions through which light within pixels does not transmit, such as at a channel unit, gate lines, storage electrode lines, and a light blocking member.

In the method of forming the bead spacers that are irregularly dispersed, the bead spacers can act as foreign particles that generate light leakage and deteriorate the contrast ratio. There have also been cases where some of the bead spacers have moved and damaged an alignment layer.

In the column spacer formation method, since an additional photolithography process is required, the unit price of products rises. Unlike the plastic-based bead spacers, the column spacers have a small LC dropping amount margin since they have low elasticity. Accordingly, filling failure and smear failure in which the spacers or a lower film is broken, may occur.

### SUMMARY OF THE INVENTION

A manufacturing apparatus for a liquid crystal display according to an exemplary embodiment of the present invention includes a spacer supply substrate in which a plurality of grooves are formed, a transfer roller having a surface to which a plurality of spacers deposited into the grooves are primarily transferred, and a support plate on which a substrate is mounted. The primarily transferred spacers are secondarily transferred onto the substrate as the transfer roller rotates, and the diameter of each of the grooves is less than or equal to about seven times the diameter of each of the spacers.

The diameter of the groove may be less than or equal to the sum of an integer multiple of a spacer diameter and a spacer radius, or the diameter of the groove may be less than or equal to a difference between an integer multiple of a spacer diameter and a spacer radius.

A depth of the groove may be greater than about 0.8 times a spacer diameter, and is smaller than about 1.2 times the spacer diameter.

Assuming that a tilt angle of the side of the groove is an angle between a vertical line of the spacer supply substrate and the side of the groove, the tilt angle of the side of the groove may be less than about 45°.

The spacers may be bead spacers. Spacers located on the surface of the transfer roller may have the same distance between them as a predetermined distance between the grooves.

The spacers may be injected into the grooves of the spacer supply substrate along with a heat-curing agent or an ultraviolet-curing agent.

The manufacturing apparatus may further include blades that move along the surface of the spacer supply substrate to deposit the spacers into the grooves. At least one of the blades contacts a surface of the spacer supply substrate.

According to an exemplary embodiment of the present invention, there is provided a spacer supply substrate in which a plurality of grooves are formed. The plurality of grooves receive a plurality of spacers therein. A diameter of each of the grooves is less than or equal to about seven times a diameter of a spacer of the plurality of spacers deposited into the grooves.

The diameter of each groove may be less than or equal to the sum of an integer multiple of a spacer diameter and a spacer radius, or the diameter of each groove may be less than or equal to a difference between an integer multiple of a spacer diameter and a spacer radius.

A depth of the groove may be greater than about 0.8 times a spacer diameter and may be smaller than about 1.2 times the spacer diameter.

Assuming that a tilt angle of the side of the groove is an angle between a vertical line of the spacer supply substrate and the side of the groove, the tilt angle of the side of the groove may be less than about 45° C.

### BRIEF DESCRIPTION OF THE DRAWINGS

Exemplary embodiments of the invention can be understood in more detail from the following descriptions taken in conjunction with the accompanying drawings in which:

FIG. 1 is a diagram of an apparatus for manufacturing a liquid crystal display according to an exemplary embodiment of the present invention.

FIG. 2 is an enlarged view of a state where the spacer ink is injected into a substrate for supplying spacers according to an exemplary embodiment of the present invention.

FIG. 3 is a view illustrating a step of depositing the spacer ink on the spacer supply substrate according to an exemplary embodiment of the present invention.

FIG. 4A is a view illustrating a step of uniformly injecting the spacer ink that has been deposited on the spacer supply substrate into a plurality of grooves according to an exemplary embodiment of the present invention.

FIG. 4B is a top plan view of a state where the spacer ink has been injected into the grooves of the spacer supply substrate according to an exemplary embodiment of the present invention.

FIG. 5 illustrates a state where the spacer ink is transferred from the spacer supply substrate to a surface of a transfer roller according to an exemplary embodiment of the present invention.

FIG. 6 illustrates a state where the spacer ink attached on the transfer roller surface is transferred onto the substrate according to an exemplary embodiment of the present invention.

FIG. 7 illustrates a state where the spacer ink transferred onto the substrate is hardened to form the spacers according to an exemplary embodiment of the present invention.

FIG. 8 is a layout view illustrating a thin film transistor array panel in which the spacers are formed by the manufacturing apparatus of the liquid crystal display according to an exemplary embodiment of the present invention.

FIG. 9 is a cross-sectional view of the thin film transistor array panel taken along line IX-IX′-IX″ in FIG. 8.

### DETAILED DESCRIPTION OF THE EMBODIMENTS

Embodiments of the present invention provide an apparatus for manufacturing a liquid crystal display, in which bead spacers can be prevented from being disposed in two levels.

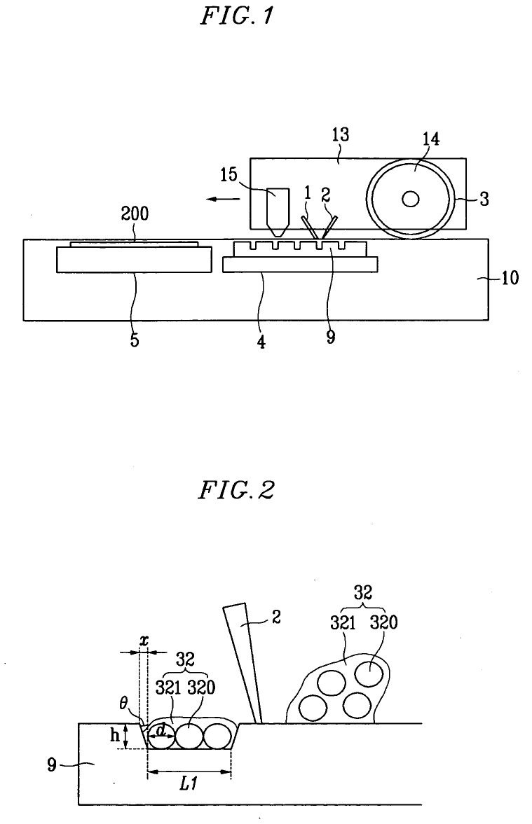

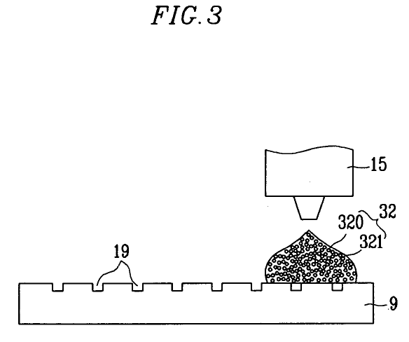

Exemplary embodiments of the present invention will now be described more fully hereinafter in more detail with reference to the accompanying drawings. This invention may, however, be embodied in different forms and should not be construed as limited to the embodiments set forth herein. FIG. 1 is a diagram of an apparatus for manufacturing a liquid crystal display according to an exemplary embodiment of the present invention, and FIG. 2 is an enlarged view of a state where the spacer ink is injected into a substrate for supplying spacers.

As shown in FIG. 1, a manufacturing apparatus of a liquid crystal display includes a spacer supply substrate 9, a transfer roller 14, a spacer supply device 15, and a support plate 5 having a display panel 200 mounted thereon.

The spacer supply substrate 9 and the support plate 5 are disposed in a lower frame 10. The transfer roller 14 and the spacer supply device 15 are disposed in an upper frame 13.

More particularly, the spacer supply substrate 9 is disposed on a printing plate 4. A plurality of grooves 19 into which spacer ink 32 is deposited are formed in the spacer supply substrate 9 with a predetermined distance between the grooves. The spacer supply substrate 9 may be formed using, for example, a glass, plastic, or metal material (e.g., stainless steel, SUS). The grooves 19 are formed in the surface of the spacer supply substrate 9 by, for example, a photolithography method, a molding method, or a laser machining method.

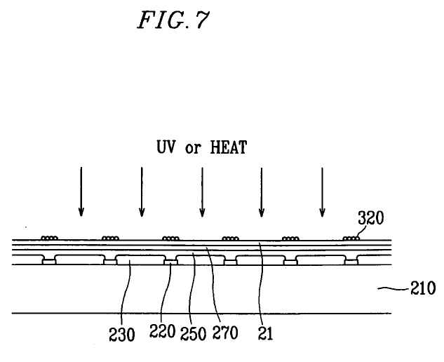

The plurality of grooves 19 are formed to have the same distance therebetween as that of patterns of spacers 320 to be formed on the display panel 200 (note FIGS. 6 and 7). In addition, the display panel 200 having the spacers 320 formed thereon is mounted on the support plate 5.

The spacer supply device 15 deposits spacer ink 32 on the spacer supply substrate 9. The spacer ink 32 includes the plurality of bead spacers 320 and a hardening agent 321 for hardening the bead spacers 320 on the display panel 200 and fixing the spacers thereon.

The bead spacers 320 comprise, for example, acrylic-based organic compounds that are capable of forming a polymer, and organic matter with a low dielectric constant such as Teflon, benzocyclobutene (BCB), cytop, and perfluorocyclobutene (PFCB).

In addition, a transfer sheet 3 made of silicon with a good hydrophilic property is attached on the surface of the transfer roller 14. Blades 1 and 2, for uniformly depositing the spacer ink 32 that has been deposited from the spacer supply device 15 to the spacer supply substrate 9 into the plurality of grooves 19 formed in the spacer supply substrate 9, are disposed at the rear of the spacer supply device 15.

As shown in FIG. 2, the plurality of bead spacers 320 and hardening agents 321 are deposited into the grooves 19 of the spacer supply substrate 9.

A diameter or width (L1) of each of the grooves 19 may be smaller than or the same as about seven times a diameter (d) of each of the spacers 320.

The number of the bead spacers 320 injected into each groove 19 of the spacer supply substrate 9 may be varied depending on the size of a predetermined cell gap and/or a mother substrate. To increase the number of bead spacers 320 disposed at a predetermined location of the display panel 200, it is required that the size of the diameter (L1) of the groove 19 of the spacer supply substrate 9 be increased. If the size of the diameter (L1) of the groove 19 is increased too much, the spacers 320 may be stacked in two levels due to an interaction between the spacer ink 32 in regions other than in the groove 19, when the spacer ink 32 is pushed by the blade 2, and the spacer ink 32 within the groove 19, when the spacer ink 32 is deposited into the groove 19 using the blade 1. As a result, defects may occur locally because the cell gap is set higher than a predetermined value. Accordingly, in the manufacturing apparatus of the liquid crystal display according to an exemplary embodiment of the present invention, to prevent such defects, the diameter (L1) of the groove 19 is set to be smaller than or the same as about seven times the diameter (d) of the spacers 320. As a result, an interaction area between the spacer ink 32 within the groove 19 and the spacer ink 32 outside the groove 19 is narrow, thereby preventing the spacers 320 from being stacked in two levels.

Furthermore, the diameter (L1) of the groove 19 may be equal to an integer multiple of the diameter (d) of each spacer 320. In more detail, the diameter (L1) of the groove 19 may be smaller than or the same as the sum of an integer multiple of the diameter (d) of the spacer 320 and a radius (d/2) of the spacer 320. As a result, a probability that the spacers 320 deposited into the groove 19 are formed in two levels can be reduced. If the diameter (L1) of the groove 19 is larger than the sum of the integer multiple of the diameter (d) of the spacer 320 and the radius (d/2) of the spacer 320, a probability that the spacers 320 may extend over the edges of the groove 19 is increased. Accordingly, to prevent extension over the edges of the groove, the diameter (L1) of the groove 19 may be set to be smaller than or the same as the sum of the integer multiple of the diameter (d) of the spacer 320 and the radius (d/2) of the spacer 320. Alternatively, the diameter (L1) of the groove 19 may be smaller than or the same as a difference between the integer multiple of the diameter (d) of the spacer 320 and the radius (d/2) of the spacer 320.

Furthermore, if a depth (h) of the groove 19 is too much greater than the diameter (d) of the spacer 320, there is a possibility that the spacers may be stacked in two levels. Accordingly, the depth (h) of the groove 19 may be greater than about 0.8 times and smaller than about 1.2 times the diameter (d) of the spacer 320.

An experimental example when the spacers 320 having a diameter of 4.0 μm are deposited into grooves of the spacer supply substrate 9 in which the depth (h) of the groove 19 is 5 μm and the diameter (L1) of the groove 19 is 22 μm, and an experimental example when the spacers 320 having a diameter of 5 μm are deposited into the grooves of the spacer supply substrate 9 in which the depth (h) of the groove 19 is 5 μm and the diameter (L1) of the groove 19 is 22 μm, are listed in Table 1.

TABLE 1

| | | |
|---|---|---|
| Diameter (μm) of spacer | 4.0 | 5.0 |
| Spacer concentration (%) of spacer ink | 35 | 35 |
| The number of spacers per groove | 7.6 | 6.5 |
| Diameter of groove/diameter of spacer | 5.5 | 4.4 |
| Depth of groove/diameter of spacer | 1.25 | 1.0 |
| Depth of groove-diameter of spacer | 1.0 | 0 |
| (depth of groove-diameter of spacer)/diameter of spacer | 0.25 | 0 |
| The ratio (%) of spacers stacked in two levels | 10 | 1 or less |

From Table 1, it can be seen that the ratio of spacers stacked in two levels is lower when the number of the spacers 320 per groove 19 is 6.5 (when the spacers 320 having a diameter 5 μm are injected) than when the number of the spacers 320 per groove 19 is 7.6.

As described above, there is a difference in the ratio of the spacers 320 stacked in two levels on the basis of whether the number of the spacers 320 per groove 19 is 7 or less. Accordingly, the diameter (L1) of the groove 19 may be smaller than or the same as about seven times the diameter (d) of the spacer 320. For example, the diameter of the groove 19 may be set less than about 5 to about 6 times the diameter (d) of the spacer 320.

In addition, when the ratio of the diameter (L1) of the groove 19 to the diameter (d) of the spacer 320 is close to an integer (e.g., when the spacers 320 having a diameter of 5 μm are injected), the ratio of the spacers 320 stacked in two levels is low. For example, in Table 1, when the spacers 320 having a diameter of 4 μm are injected, the ratio of the diameter (L1) of the groove 19 to the diameter (d) of the spacers 320 is 5.5. When the spacers 320 having a diameter of 5 μm are injected, the ratio of the diameter (L1) of the groove 19 to the diameter (d) of the spacers 320 is 4.4. Accordingly, when the spacers 320 have a diameter of 5 μm, the ratio of the diameter (L1) of the groove 19 to the diameter (d) of the spacers 320 is closer to an integer multiple than when the spacers have a diameter of 4 μm. As a result, the ratio of the 5 μm spacers 320 stacked in two levels, according to the experimental example, is lower than that for the 4 μm spacers.

More particularly, when the diameter (L1) of the groove 19 is smaller than or the same as the sum of the integer multiple of the diameter (d) of the spacer 320 and the radius (d/2) of the spacer 320, the ratio of the spacers 320 stacked in two levels is low. If the diameter (L1) of the groove 19 is larger than the sum of the integer multiple of the diameter (d) of the spacer 320 and the radius (d/2) of the spacer 320, a portion of the remaining spacers 320 is likely to fill into a space that remains after the groove 19 is filled with the spacers 320. Accordingly, the remaining spacers 320 are likely to extend over the edges of the groove 19. If the diameter (L1) of the groove 19 is smaller than or the same as the sum of the integer multiple of the diameter (d) of the spacer 320 and the radius (d/2) of the spacer 320, however, the remaining spacers 320 are less likely to fill into the space that remains after the groove 19 is filled with the spacers 320. Accordingly, the remaining spacers 320 do not extend over the edges of the groove 19.

In addition, when the ratio of the depth (h) of the groove 19 and the diameter (d) of the spacer 320 is closer to one (e.g., when the spacers 320 having a diameter of 5 μm are injected), the ratio of the spacers 320 stacked in two levels is low. More particularly, it is preferred that the depth (h) of the groove 19 is larger than about 0.8 times and smaller than about 1.2 times the diameter (d) of the spacer 320. If the depth (h) of the groove 19 is smaller than about 0.8 times the diameter (d) of the spacer 320, the spacers 320 are not filled into the groove 19, but are exposed over the groove 19. Accordingly, transfer failure may occur in subsequent processes. Meanwhile, if the depth (h) of the groove 19 is greater than about 1.2 times the diameter (d) of the spacer 320, the spacers 320 may be be stacked in two levels.

Furthermore, assuming that a tilt angle (θ) of the side of the groove 19 is an angle between a vertical line of the spacer supply substrate 9 and the side of the groove 19, the tilt angle (θ) of the side of the groove 19 may be less than about 45°. A tilt angle (θ) less than or equal to about 45° aids in preventing the spacers from being stacked in two levels. For example, when the tilt angle (θ) is 45° as shown in FIG. 2, and h=d, tan 45=x/d=1, results in x=d. Accordingly, a space where a spacer 320 can extend over the edges of the groove 19 is generated. Therefore, when the tilt angle (θ) of the side of the groove 19 is greater than or the same as 45°, any one spacer 320 may extend over the edges of the groove 19.

A method of manufacturing a liquid crystal display using the manufacturing apparatus of the liquid crystal display constructed above according to an exemplary embodiment of the present invention will be described below in detail.

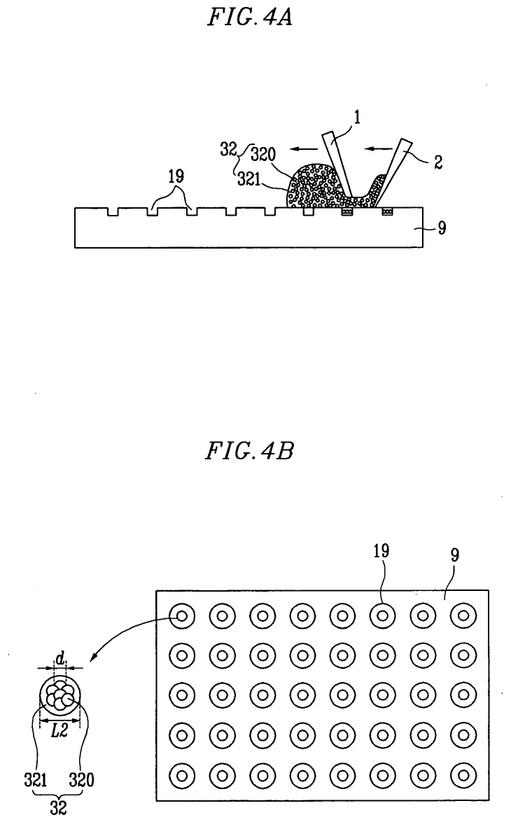

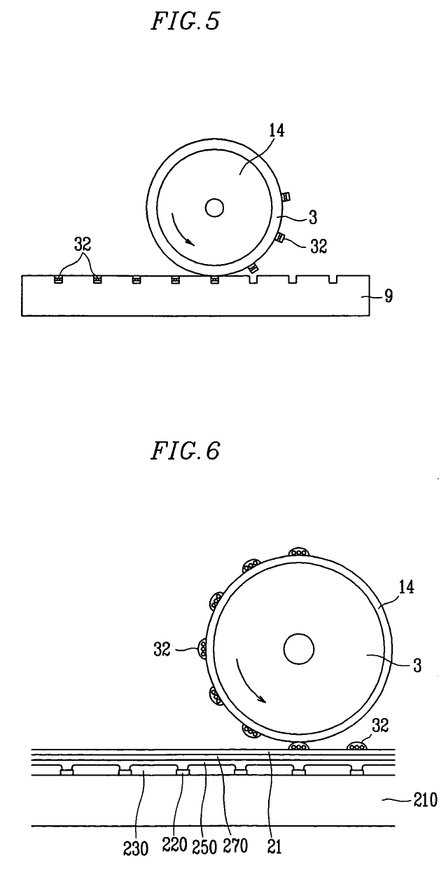

FIG. 3 is a view illustrating a step of dropping the spacer ink on the spacer supply substrate. FIG. 4A is a view illustrating a step of uniformly injecting the spacer ink that has been deposited on the spacer supply substrate into the plurality of grooves. FIG. 4B is a top plan view of a state where the spacer ink has been injected into the grooves of the spacer supply substrate. FIG. 5 illustrates a state where the spacer ink is transferred from the spacer supply substrate to a surface of the transfer roller. FIG. 6 illustrates a state where the spacer ink attached on the surface of the transfer roller is transferred onto the substrate. FIG. 7 illustrates a state where the spacer ink transferred onto the substrate is hardened to form the spacers.

As shown in FIG. 3, the spacer ink 32 is deposited on the spacer supply substrate 9 using the spacer supply device 15. The spacer ink 32 includes the plurality of bead spacers 320 and, for example, a heat-curing agent or an ultraviolet-curing agent 321.

As shown in FIG. 4A, the spacer ink 32 is deposited into the plurality of grooves 19 formed in the spacer supply substrate 9 using the blades 1 and 2. The plurality of bead spacers 320 form a collection, as shown in FIG. 4B, and are deposited into the grooves 19 along with the hardening agent 321. The size (L2) of the spacer ink 32 injected into the groove 19 may be smaller than the diameter (L1) of the groove 19.

As shown in FIG. 5, as the transfer roller 14 rotates, the spacer ink 32 is transferred onto the surface of the transfer sheet 3 of the transfer roller 14 in portions. The spacer ink 32 has the same interval between the portions as a predetermined interval between the grooves 19, and is adhered to the surface of the transfer sheet 3.

As shown in FIG. 6, the transfer roller 14, having the plurality of spacer ink 32 portions that are adhered to its surface, transfers the plurality of spacer ink 32 portions to the display panel 200 mounted on the support plate 5 while moving over the support plate 5. Therefore, the spacer ink 32 is disposed at predetermined locations on the display panel 200 at regular intervals.

FIG. 6 shows a state where the spacer ink 32 is transferred to the display panel 200 on which a light blocking member 220, a color filter 230, an overcoat film 250, a common electrode 270, and an alignment layer 21 are sequentially formed. Alternatively, the spacer ink 32 may be transferred before the alignment layer 21 is formed. At this time, the spacers 320 can be accurately disposed at regions corresponding to the light blocking members 220 in order to prevent the occurrence of light leakage.

As shown in FIG. 7, the spacers 320 that have been transferred along with the heat-curing agent or the ultraviolet-curing agent 321 are cured and are firmly adhered to the display panel 200 by means of heat or ultraviolet rays.

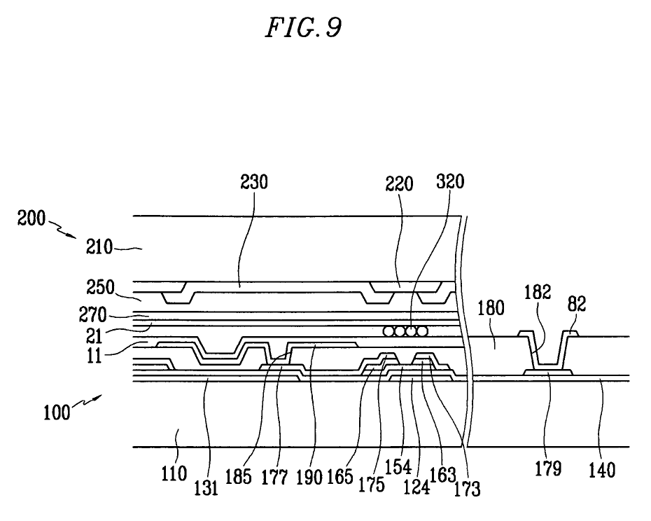

Referring to FIG. 9, the upper panel 200 on which the spacers 320 are disposed is positioned opposite a lower panel 100, and pressure is applied to the upper panel 200 on the lower panel 100 to attached the upper panel 200 to the lower panel 100.

By forming the plurality of bead spacers 320 at predetermined locations of the display panel 200 using the transfer roller 14 as described above, uniform cell gaps can be formed and elastic force can be enhanced. It is therefore possible to prevent smear failure, which may occur when pressure is applied to the display panel 200. In other words, both the merits of the bead spacers having a high elastic force and simple process and the merits of the column spacers, in which light leakage can be eliminated since the spacers are formed at predetermined locations, can be obtained. In addition, since the process itself is simplified, process management can be facilitated and the yield can be stabilized.

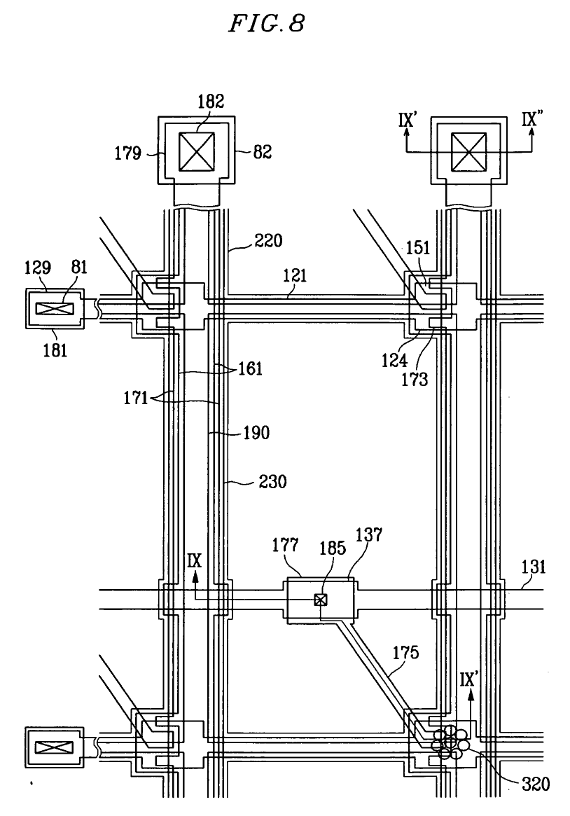

FIG. 8 is a layout view illustrating a thin film transistor array panel in which the spacers are formed by the manufacturing apparatus of the liquid crystal display according to an exemplary embodiment of the present invention. FIG. 9 is a cross-sectional view of the thin film transistor array panel taken along line IX-IX′-IX″ in FIG. 8.

A plurality of gate lines 121 and a plurality of storage electrode lines 131 are formed on an insulation substrate 110 made of, for example, transparent glass, plastic or the like.

The gate lines 121 transfer gate signals, and mainly extend in a horizontal direction. Each of the gate lines 121 includes a plurality of gate electrodes 124 protruding therefrom, for example, downwardly, and an end portion 129 having a wide area for connection with other layers or an external driving circuit. A gate driving circuit (not shown) that generates the gate signals may be mounted on a flexible printed circuit film (not shown) adhered on the substrate 110, may be directly mounted on the substrate 110, or may be integrated with the substrate 110. When the gate driving circuit is integrated on the substrate 110, the gate lines 121 may extend and be directly connected to the gate driving circuit.

The storage electrode lines 131 are applied with a predetermined voltage and extend substantially parallel to the gate lines 121. Each of the storage electrode lines 131 is located between two adjacent gate lines 121 and may be closer to one of the two gate lines 121, for example, a lower gate line. Each of the storage electrode lines 131 includes a storage electrode 137 that extends, for example, upward and downward. However, the shape and arrangement of the gate and storage electrode lines 121, 131 may be modified in various manners.

The gate lines 121 and the storage electrode lines 131 may be formed using, for example, an aluminum-based metal such as aluminum (Al) or an aluminum alloy, a silver-based metal such as silver (Ag) or a silver alloy, a copper-based metal such as copper (Cu) or a copper alloy, a molybdenum-based metal such as molybdenum (Mo) or a molybdenum alloy, chromium (Cr), tantalum (Ta), titanium (Ti), or the like. The gate and storage lines 121, 131 may have a multi-film structure including two conductive layers (not shown) having different physical properties. For example, one of the conductive layers may be formed using a metal having low resistivity, such as an aluminum-based metal or a copper-based metal, in order to reduce signal delay or voltage drop. Other conductive layers may be formed using materials having good physical, chemical, and electrical contact characteristics with ITO (indium tin oxide) and IZO (indium zinc oxide), such as a molybdenum-based metal, chromium, tantalum, titanium, or the like. Examples of the combination may include a lower chromium film and an upper aluminum (alloy) film, and a lower aluminum (alloy) film and an upper molybdenum (alloy) film. It is, however, to be understood that the gate lines 121 and the storage electrode lines 131 may be formed using a variety of metals or conductors other than the above-mentioned materials.

The sides of the gate lines 121 and the storage electrode lines 131 can be tilted with respect to the surface of the substrate 110. The tilt angle may be in the range of about 30° to about 80°.

A gate insulating layer 140 made of, for example, silicon nitride (SiNx) or silicon oxide (SiOx) is formed on the gate lines 121 and the storage electrode lines 131.

On the gate insulating layer 140 are formed a plurality of semiconductor stripes 151 made of, for example, hydrogenated amorphous silicon (amorphous silicon is commonly abbreviated to “a-Si”), polysilicon, or the like. Each semiconductor stripe 151 usually extends in a vertical direction and includes a plurality of projections 154 extending toward the gate electrodes 124. The semiconductor stripe 151 has a width that widens near the gate lines 121 and the storage electrode lines 131, and covers the gate lines 121 and the storage electrode lines 131.

On the semiconductor stripes 151 are formed a plurality of linear and island ohmic contacts 161 and 165. The ohmic contacts 161 and 165 may be formed using a material such as n+ hydrogenated amorphous silicon into which an n-type impurity is doped at a high concentration, or silicide. The linear ohmic contact 161 has a plurality of projections 163. The projection 163 and the island type ohmic contact 165 form a pair and are then disposed on the projection 154 of the semiconductor stripe 151.

The sides of the island type semiconductors 151 and the ohmic contacts 161 and 165 can also be tilted with respect to the surface of the substrate 110. The tilt angle may be within a range of about 30° to about 80°.

On the ohmic contacts 161 and 165 and the gate insulating layer 140 are formed a plurality of data lines 171 and a plurality of drain electrodes 175.

The data lines 171 function to transfer the data signals. The data lines 171 extend in a vertical direction and cross the gate lines 121 and the storage electrode lines 131. Each of the data lines 171 includes a plurality of source electrodes 173 extending toward the gate electrodes 124 and an end portion 179 having a wide area for connection with other layers or an external driving circuit. A data driving circuit (not shown) that generates the data signal may be mounted on a flexible printed circuit film (not shown) adhered on the substrate 110, may be directly mounted on the substrate 110, or may be directly integrated with the substrate 110. In the case where the data driving circuit is integrated on the substrate 110, the data lines 171 may extend and be directly connected to the data driving circuit.

Drain electrodes 175 are separated from the data lines 171 and are opposite to the source electrodes 173 with respect to the gate electrodes 124. Each of the drain electrodes 175 includes one wide end portion and another pole-shaped end portion. The wide end portion of the drain electrode 175 is overlapped with the storage electrodes 137 and the pole-shaped end portion thereof is partially surrounded by the source electrodes 173.

One gate electrode 124, one source electrode 173, and one drain electrode 175 form one thin film transistor (TFT) along with the projection 154 of the semiconductor stripe 151. A channel of the thin film transistor is formed at the projection 154 between the source electrode 173 and the drain electrode 175.

The data lines 171 and the drain electrodes 175 may be formed using, for example, a refractory metal such as molybdenum, chromium, tantalum, or titanium, or an alloy thereof, and may have a multi-film structure including a refractory metal film (not shown) and a low resistance conductive layer (not shown). Examples of the multi-film structure may include a dual film of a lower chromium or molybdenum film and an upper aluminum (alloy) film, and a triple film of a lower molybdenum (alloy) film, an intermediate aluminum (alloy) film, and an upper molybdenum (alloy) film. It is, however, to be noted that the shape and arrangement of the data lines 171 and the drain electrodes 175 may be modified in various manners and the data lines 171 and the drain electrodes 175 may be formed using various metals or conductors other than the above-mentioned materials.

The sides of the data lines 171 and the drain electrodes 175 may have a tilt angle of about 30° to about 80° with respect to the surface of the substrate 110.

The ohmic contacts 161 and 165 are located between the semiconductor stripe 151 below the ohmic contacts 161 and 165, and the data lines 171 and the drain electrodes 175 on the ohmic contacts 161 and 165, and function to reduce contact resistance therebetween. In most locations, the semiconductor stripe 151 is narrower than the data lines 171. However, as described above, the semiconductor stripe 151 has a wider width where it meets the gate lines 121, thereby smoothing the profile of the surface. It is therefore possible to prevent the data lines 171 from being shorted. The semiconductor stripe 151 includes exposed portions that are not covered by the data lines 171 and the drain electrode 175, which are located, for example, between the source electrode 173 and the drain electrode 175.

A passivation layer 180 is formed on the data lines 171, the drain electrodes 175, and the exposed semiconductor stripe 151 portions. The passivation layer 180 may be formed using, for example, an inorganic insulator, an organic insulator, or the like, and may have a flat surface. Examples of the inorganic insulator may include silicon nitride and silicon oxide. The organic insulator may have photosensitivity, and may have a dielectric constant of about 4.0 or less. Alternatively, the passivation layer 180 may have a dual film structure of, for example, a lower inorganic film and an upper organic film so that it prevents damage to the exposed semiconductor stripe 151 portion, while maintaining the desired insulating characteristic of the organic film.

In the passivation layer 180 are formed a plurality of contact holes 182 and 185 through which the end portions 179 of the data lines 171 and the drain electrodes 175 are exposed, respectively. In the passivation layer 180 and the gate insulating layer 140 are formed a plurality of contact holes 181 through which the end portions 129 of the gate lines 121 are exposed.

On the passivation layer 180 are formed a plurality of pixel electrodes 190 and a plurality of contact assistants 81 and 82. The plurality of pixel electrodes 190 and the plurality of contact assistants 81 and 82 may be formed using, for example, a transparent conductive material such as ITO or IZO, or a reflective metal such as aluminum, silver, chromium, or an alloy thereof.

The pixel electrodes 190 are physically and electrically connected to the drain electrodes 175 through contact holes 185, and are supplied with a data voltage from the drain electrodes 175. The pixel electrodes 190 to which the data voltage has been applied generate an electric field along with the common electrode 270 of the other display panel to which a common voltage is applied, thereby determining the orientation of liquid crystal molecules of a liquid crystal layer between the two electrodes 190 and 270. The polarization of light that passes through the liquid crystal layer is changed according to the orientation of liquid crystal molecules, which is determined as described above. The pixel electrodes 190 and the common electrode 270 constitute a capacitor (hereinafter, referred to as a “liquid crystal capacitor”). The capacitor retains a voltage applied thereto even after the thin film transistor is turned off.

The pixel electrodes 190 and the drain electrodes 175 connected to the pixel electrodes 190 are overlapped with the storage electrode lines 131. A capacitor, in which the pixel electrodes 190 and the drain electrodes 175 electrically connected to the pixel electrodes 190 are overlapped with the storage electrode lines 131, is called a “storage capacitor”. The storage capacitor enhances the voltage sustaining capability of the liquid crystal capacitor.

The contact assistants 81 and 82 are connected to the end portions 129 of the gate lines 121 and the end portions 179 of the data lines 171 through the contact holes 181 and 182, respectively. The contact assistants 81 and 82 compensate for adhesiveness between the end portions 129 of the gate lines 121 and the end portions 179 of the data lines 171 and an external apparatus, and also protect the end portions 129, 179.

A lower alignment layer 11 that determines the alignment of the liquid crystal molecules is formed on the pixel electrodes 190.

A common electrode panel will be described in detail with reference to the drawings.

An insulation substrate 210 made of, for example, transparent glass, plastic, or the like is disposed above and spaced apart from the lower alignment layer 11 by a predetermined distance. A light blocking member 220, such as a black matrix, is formed on the insulation substrate 210 in a matrix form. The light blocking members 220 divide the pixel area. Color filters for representing three primary colors that are necessary to display an image, such as a red filter, a green filter, and a blue filter, are formed between the light blocking members 220 while being partially overlapped with the light blocking members 220.

The red filter, green filter, and blue filter may be formed in a stripe form. Alternatively, the red filter, green filter, and blue filter may be separatedly provided for each pixel.

To protect the light blocking members 220 and the color filters, an overcoat film 250 is formed on the light blocking members 220 and the color filters 230. The overcoat film 250 may be formed of an organic insulating material. The overcoat film 250 functions to prevent the color filters 230 from being exposed and provides a flat surface. The overcoat film 250 may be omitted.

On the overcoat film 250 is formed the common electrode 270, which is made of a transparent conductor such as ITO or IZO, and it forms an electric field along with the pixel electrodes 190. The upper alignment layer 21 is formed on the common electrode 270.

The plurality of bead spacers 320 are disposed on the upper alignment layer 21 corresponding to the light blocking members 220. The plurality of bead spacers assist in maintaining a uniform cell gap and can enhance elastic force. Therefore, they can prevent smear failure, which may occur when pressure is applied to the display panel 200.

In accordance with the manufacturing apparatus of the liquid crystal display according to embodiments of the present invention, the diameter and depth of the grooves of the spacer supply substrate and the tilt angle of the sidewall of the grooves are controlled. It is therefore possible to prevent the bead spacers from being stacked in two levels.

Although the illustrative embodiments have been described herein with reference to the accompanying drawings, it is to be understood that the present invention is not limited to those precise embodiments, and that various other changes and modifications may be affected therein by one of ordinary skill in the related art without departing from the scope or spirit of the invention. All such changes and modifications are intended to be included within the scope of the invention as defined by the appended claims.

What is claimed is:

1. A manufacturing apparatus for a liquid crystal display, comprising:
a spacer supply substrate in which a plurality of grooves are formed;
a transfer roller having a surface to which a plurality of spacers deposited into the grooves are primarily transferred; and
a support plate on which a substrate is mounted, wherein the primarlily transferred spacers are secondarily transferred onto the substrate as the transfer roller rotates,
wherein a diameter of each of the grooves is less than or equal to about seven times a diameter of a spacer.

2. The manufacturing apparatus of claim 1, wherein the diameter of the groove is less than or equal to a sum of an integer multiple of the spacer diameter and a spacer radius.

3. The manufacturing apparatus of claim 1, wherein the diameter of the groove is less than or equal to a difference between an integer multiple of the spacer diameter and a spacer radius.

4. The manufacturing apparatus of claim 1, wherein a depth of the groove is greater than about 0.8 times the spacer diameter and is less than about 1.2 times the spacer diameter.

5. The manufacturing apparatus of claim 1, wherein a tilt angle of a side of the groove is less than about 45°, the tilt angle being an angle between a vertical line of the spacer supply substrate and the side of the groove.

6. The manufacturing apparatus of claim 1, wherein the spacers are bead spacers.

7. The manufacturing apparatus of claim 1, wherein the primarily transferred spacers have a same distance between them as a distance between the grooves.

8. The manufacturing apparatus of claim 1, wherein the spacers are deposited into the grooves of the spacer supply substrate with a heat-curing agent or an ultraviolet-curing agent.

9. The manufacturing apparatus of claim 1, further comprising blades that move along the surface of the spacer supply substrate to deposit the spacers into the grooves.

10. The manufacturing apparatus of claim 9, wherein at least one of the blades contacts a surface of the spacer supply substrate.

11. A spacer supply substrate comprising:
a plurality of grooves formed in the spacer supply substrate for receiving a plurality of spacers, wherein a diameter of each of the grooves is less than or equal to about seven times a diameter of a spacer of the plurality of spacers.

12. The spacer supply substrate of claim 11, wherein the diameter of the groove is less than or equal to a sum of an integer multiple of the spacer diameter and a spacer radius.

13. The spacer supply substrate of claim 11, wherein the diameter of the groove is less than or equal to a difference between an integer multiple of the spacer diameter and a spacer radius.

14. The spacer supply substrate of claim 11, wherein a depth of the groove is greater than about 0.8 times the spacer diameter and is smaller than about 1.2 times the spacer diameter.

15. The spacer supply substrate of claim 11, whereina tilt angle of a side of the groove is less than about 45°, the tilt angle being an angle between a vertical line of the spacer supply substrate and the side of the groove.
